(19) United States
(12) Patent Application Publication
(10) Pub. No.: US 2006/0277519 A1
(43) Pub. Date: Dec. 7, 2006

(54) System and method for optical proximity correction

(76) Inventors: Stephane Dufrenne, Portofino (SG); Ming Chien Adrian Soh, Singapore (SG)

Correspondence Address: HARNESS, DICKEY, & PIERCE, P.L.C, 7700 BONHOMME, STE 400, ST. LOUIS, MO, 63105, US

(21) Appl. No.: 11/146,386

(22) Filed: Jun. 6, 2005

(51) Int. Cl. G06F 17/50

(52) U.S. Cl. 716/19

(57) ABSTRACT

A method of optical proximity correction is described. The method includes selecting all islands, increasing the size of each said island. The facing sides of each island is pulled back equally if island to island spacing is insufficient between two islands. A further step of pulling back equally the facing sides of an island and a continent if island to continent spacing is insufficient between the island and the continent.

### TECHNICAL FIELD

This invention relates to a method and system of optical proximity correction for correcting wafer chip designs to minimise active island pattern bridging and fall over or toppling.

### BACKGROUND ART

Optical proximity correction is used to correct wafer designs. Optical proximity correction is used to counter the optical proximity effects of light during litho exposure. In particular integrated circuit designs may not print as intended on a wafer. This is particularly so for smaller features that are now in use such as active islands. With active island patterns the produced wafer without optical proximity correction may have active island pattern bridging or toppling points.

Existing technologies use symmetric sizing, where all sides of an island (minimum area of a design specification) are extended the same distance; with closely spaced islands this causes difficulty. While it would be desirable to extend greater distances where there is space present technology does not provide for this.

### DISCLOSURE OF INVENTION

It is an object of the present invention to overcome the above disadvantages or at least provide the public or industry with useful choice.

Accordingly in a first embodiment the present invention consists of a method of optical proximity correction comprising the steps of:

selecting all islands;

increasing the size of each said island;

pulling back equally the facing sides of two islands if island to island spacing is insufficient between said two islands; and

pulling back equally the facing sides of an island and a continent if island to continent spacing is insufficient between said island and said continent;

Preferably an island is an area less than or equal to 0.11 μm².

Preferably a continent is an area greater than 0.11 μm².

Preferably all islands are increased in size by 94 nm on each side.

Preferably a sufficient spacing between two said islands is 0.212 μm.

Preferably a sufficient spacing between an island and a continent is 0.208 μm.

Preferably said pull back per side between islands is 76 nm.

Preferably said pull back per side between an island and a continent is 28 nm.

Accordingly in a second embodiment the present invention consists of a system implementing any of the above methods.

Accordingly in a third embodiment the present invention consists of software for affecting any of the above methods.

Accordingly in a fourth embodiment the present invention consists of storage media containing software for affecting any of the above methods.

### BRIEF DESCRIPTION OF THE DRAWINGS

FIG. 1 is a schematic illustration of a wafer design showing islands and continents before the technology of the present invention is applied;

FIG. 2 is a schematic illustration of a wafer design after the first step of the technology of the present invention is applied;

FIG. 3 is a schematic illustration of a wafer design after scaling up the islands;

FIG. 4A is a schematic illustration of a wafer design after scaling up the islands showing identified close areas between islands;

FIG. 4 is a schematic illustration of a wafer design after scaling up the islands showing the close areas that need to be removed between islands;

FIG. 5 is a schematic illustration of a wafer design after removal of the close areas between islands;

FIG. 6A is a schematic illustration of a wafer design showing identified close areas between islands and continents;

FIG. 6 is a schematic illustration of a wafer design showing the close areas that need to be removed between islands and continents;

FIG. 7 is a schematic illustration of the wafer design after the close areas between islands and continents have been removed;

FIG. 8 is a schematic illustration of the transform of the wafer design; and

FIG. 9 is a picture of a wafer showing active bridging.

### BEST MODES FOR CARRYING OUT THE INVENTION

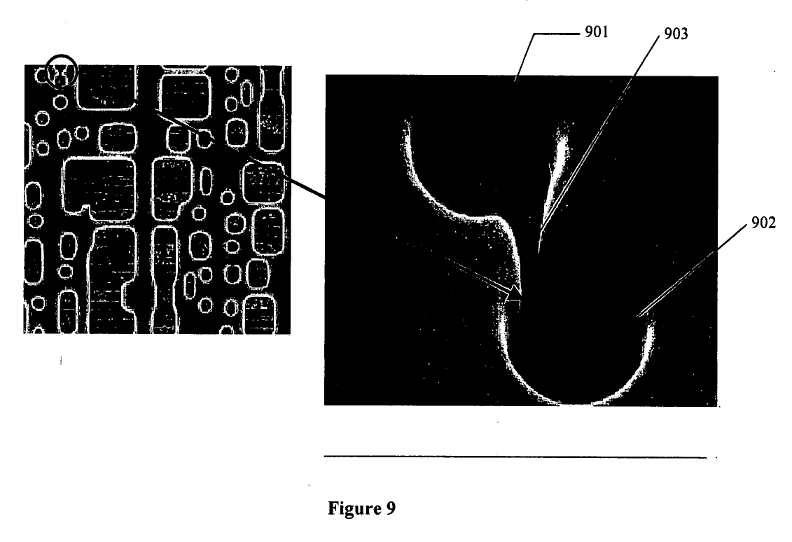

Referring to FIG. 9 the problem of active bridging where two islands 901, 902 of a wafer end up bridging 803, that is the two islands 901, 902 that are supposed to be disconnected end up connected.

Optical Proximity Correction of the wafer design is used to try and avoid this problem. Optical Proximity Correction is applied to a wafer design database in order to obtain satisfactory results from the manufactured wafers. The present invention relates to an improved method of optical proximity correction, which in tests carried out has improved wafer yield.

The present invention is described with reference to 0.16 μm design rules. These rules specify the minimum active spacing as 0.244 μm and specify the minimum active area as 0.068 μm. When creating new designs, designers adhere to these rules. As estimated from litho simulations, the specifications to ensure manufacturable wafers, without active island pattern bridging or toppling, are, that the minimum active area must be at least 0.11 μm², the minimum spacing island to island must be at least greater than 0.212 μm and the minimum spacing island to continent must be at least greater than 0.208 μm.

The present invention adds to the design rules that if an island is surrounded by islands on all four sides then the space between the surrounded island and at least one of the surrounding islands must be greater than 0.332 μm. Without this requirement there is insufficient space to grow the central island to the desired minimum area.

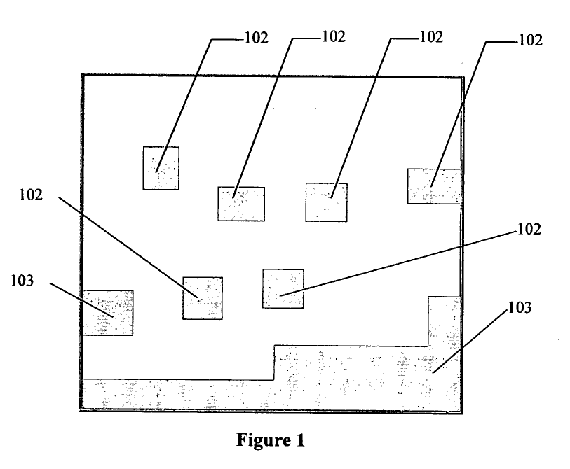

Referring to FIG. 1 a schematic of a wafer active layer is illustrated in which the wafer includes islands 102 and continents 103. In terms of 0.16 μm technology, an island 101 is any active area less than or equal to 0.11 μm² and a continent is any area greater than 0.11 μm². Other design specifications or technology will specify different areas as islands and continents.

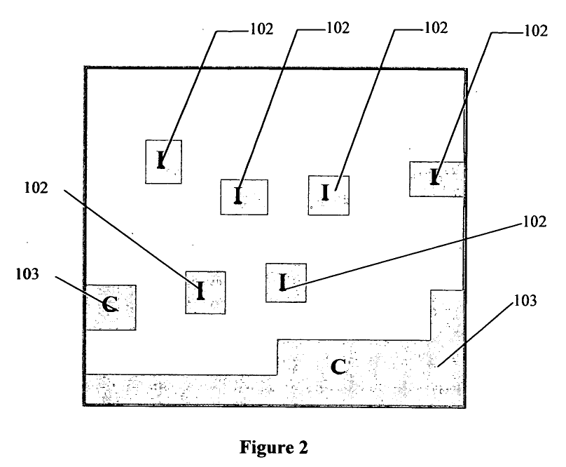

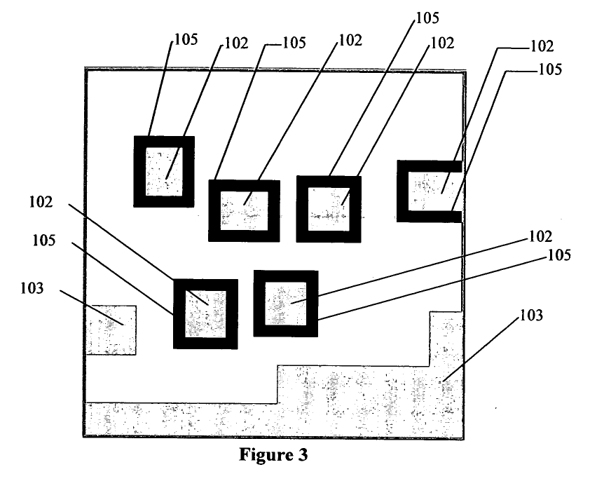

In a first step referring to FIG. 2 the technology of the present invention identifies the islands 102 and the continents 103. All islands are then scaled up so as to achieve a minimum area of 0.11 μm². In the case of 0.16 μm technology, islands are sized-up by 94 nm per side, the scaled up portions are shown in FIG. 3 in bold and are marked 105.

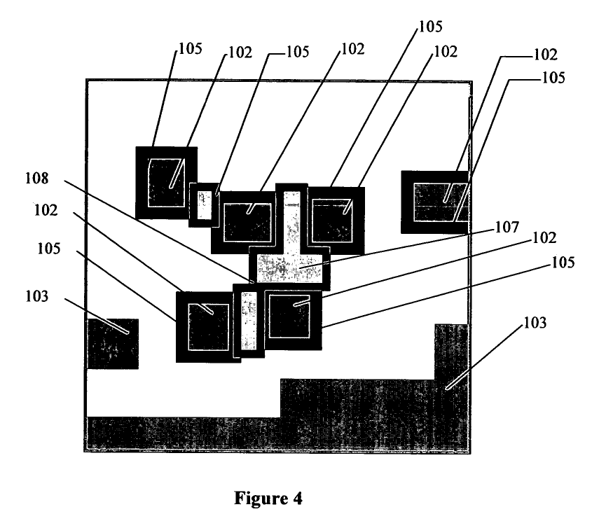

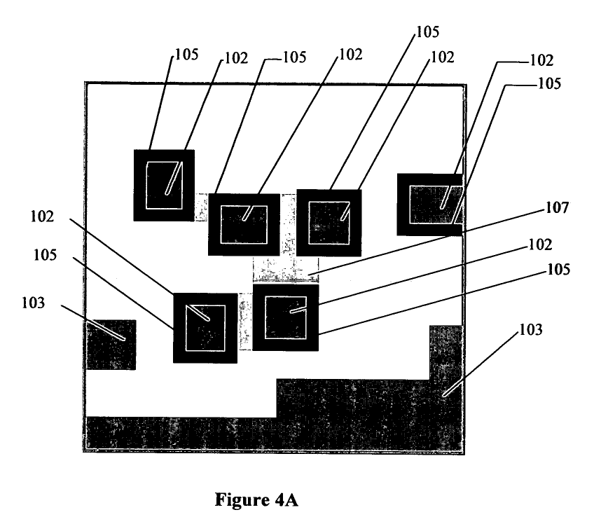

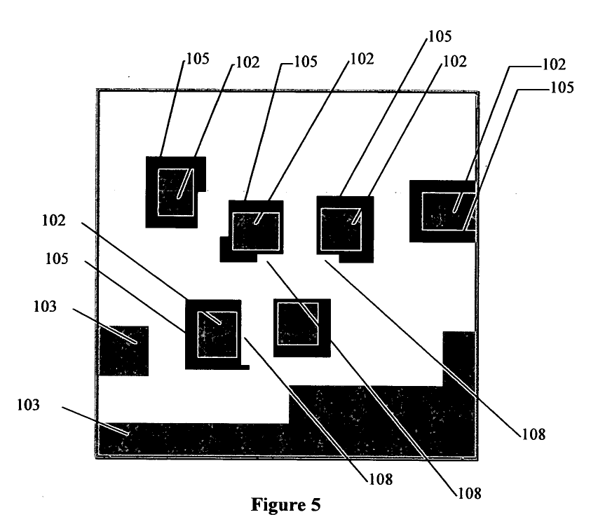

Referring to FIG. 4A the present invention then identifies areas where the minimum allowed space as calculated from litho simulations 107 between islands 102 is breached. In the case of 0.16 μm technology this minimum spacing has been calculated as at least 0.212 μm. Referring to FIG. 4 the needed reduction 108 is shown in dark grey. The system then scales back the islands 102 accordingly. In the case of 0.16 μm technology the scale back is 76 nm per side. The scaled back islands 102 can be seen in FIG. 5, where the islands 102 are reduced in size from the size they would have been if symmetric scaling had been used. The reduced areas are identified by numeral 108.

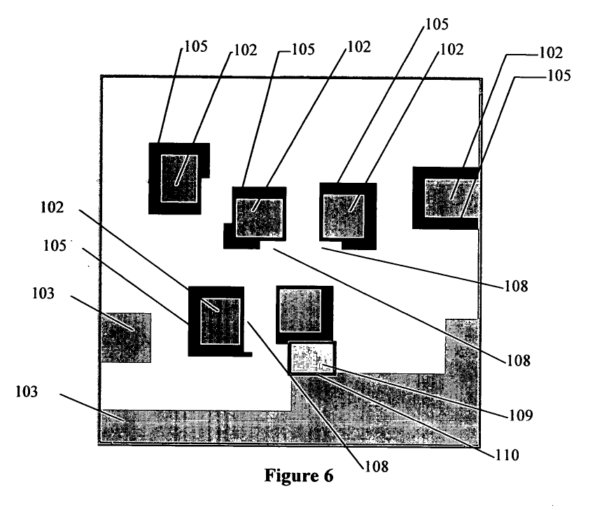

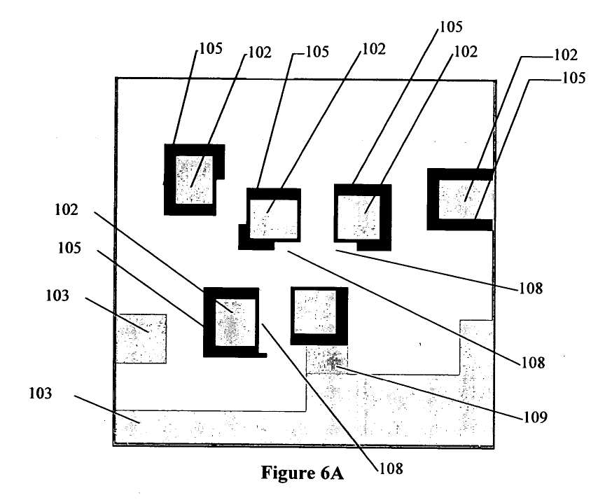

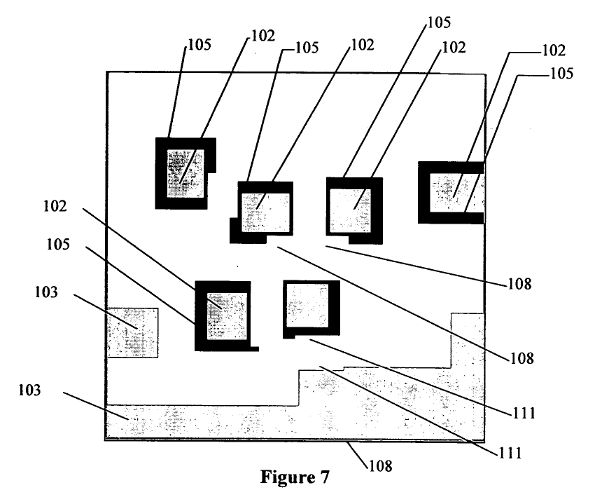

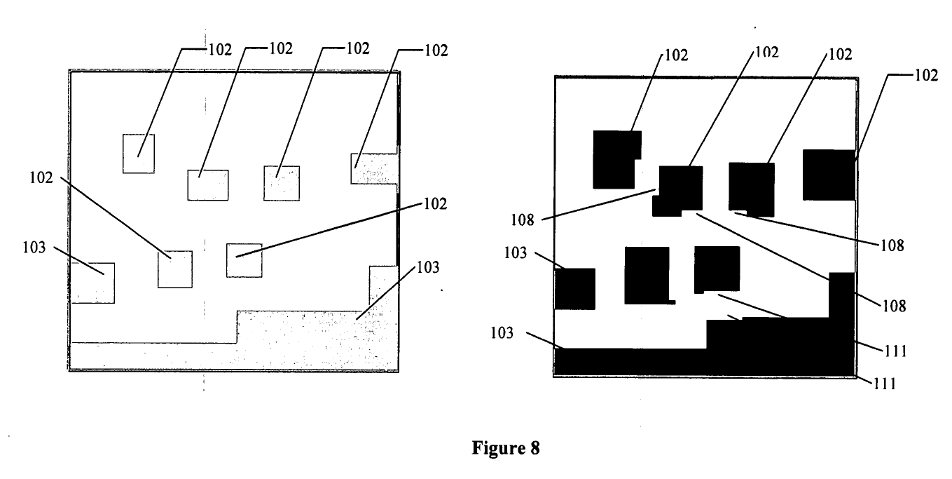

A minimum space between islands 102 and continents 103 is also required. When using 0.16 μm technology the minimum space as calculated from litho simulations is 0.208 μm. In FIG. 6A breaches of the minimum space between an island and a continent are identified 109 and shown in grey. Referring to FIG. 6 the needed reduction 110 is shown in dark grey. The system then scales back the islands 102 and continents 103 accordingly. In the case of 0.16 μm technology the scale back is 28 nm per side. The scaled back islands 102 and continents 103 can be seen in FIG. 7, where the islands 102 and continents 103 are reduced in size from the size they would have been if symmetric scaling had been used. The reduced areas are identified by numeral 111. FIG. 8 shows the difference between the design after the present invention has been applied.

It will be appreciated that the present invention can be implemented in software as part of existing wafer design and optical proximity correction tools. An example of such a tool is Computer Aided Transcription System provided by Synopsys Private Limited.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A method of optical proximity correction comprising the steps of:
selecting all islands;
increasing the size of each said island;
pulling back equally the facing sides of two islands if island to island spacing is insufficient between said two islands; and
pulling back equally the facing sides of an island and a continent if island to continent spacing is insufficient between said island and said continent.

2. A method of optical proximity correction as claimed in claim 1 wherein an island is an area less than or equal to 0.11 μm² and a continent is an area greater than 0.11 μm².

3. A method of optical proximity correction as claimed in claim 2 wherein all islands are increased in size by 94 nm on each side.

4. A method of optical proximity correction as claimed in claim 3 wherein a sufficient spacing between two said islands is 0.212 μm.

5. A method of optical proximity correction as claimed in claim 4 wherein a sufficient spacing between an island and a continent is 0.208 μm.

6. A method of optical proximity correction as claimed in claim 5 wherein said pull back per side between islands is 76 nm.

7. A method of optical proximity correction as claimed in claim 6 wherein said pull back per side between an island and a continent is 28 nm.

8. A method of optical proximity correction as claimed in claim 2 wherein a sufficient spacing between two said islands is 0.212 μm.

9. A method of optical proximity correction as claimed in claim 2 wherein a sufficient spacing between an island and a continent is 0.208 μm.

10. A method of optical proximity correction as claimed in claim 2 wherein said pull back per side between islands is 76 nm.

11. A method of optical proximity correction as claimed in claim 2 wherein said pull back per side between an island and a continent is 28 nm.

12. A system implementing the method of claim 1.

13. A system implementing the method of claim 2.

14. A system implementing the method of claim 7.

15. Software for affecting the method of claim 1.

16. Software for affecting the method of claim 2.

17. Software for affecting the method of claim 7.

18. Storage media containing software for affecting the method of claim 1.

19. Storage media containing software for affecting the method of claim 2.

20. Storage media containing software for affecting the method of claim 7.
